(19) United States
(12) Patent Application Publication
(10) Pub. No.: US 2018/0320028 A1
(43) Pub. Date: Nov. 8, 2018

(54) COMBINED ADHESIVE SYSTEM FOR FLYING SPLICE TAPE AND DOUBLE-SIDED TAPE

(71) Applicant: tesa SE, Norderstedt (DE)

(72) Inventor: Metin OZSOBACI, Chicago, IL (US)

(21) Appl. No.: 15/589,494

(22) Filed: May 8, 2017

(51) Int. Cl. C09J 7/02; B32B 37/12; B32B 7/12; B65H 19/18

(52) U.S. Cl. CPC C09J 7/02; B32B 37/12; B32B 7/12; B65H 19/1805; B65H 2301/46312; C09J 2203/342; C09J 2201/40; B65H 2301/46078; B32B 2405/00

(57) ABSTRACT

Adhesive tapes and methods for splicing low surface energy substrates with flying splices are provided. An example adhesive tape comprises an adhesive layer and a backing adjacent to the adhesive layer. The adhesive layer comprises a first adhesive comprising a higher shear resistance, cohesive strength, and surface energy relative to a second adhesive, and the second adhesive comprises a higher tack for low surface energy substrates relative to the first adhesive. The second adhesive is different from the first adhesive. The second adhesive is adjacent to the first adhesive and there is substantially no overlap between the first adhesive and second adhesive.

### TECHNICAL FIELD

The present disclosure relates to adhesive tapes used for making flying splices, and more particularly, to single-sided and double-sided adhesive tapes comprising a combined adhesive system to improve adherence on low surface energy substrates in a flying splice operation.

### BACKGROUND

A flying splice is a method of splicing a new roll of a material to an expiring roll of material as the expiring roll is almost completely unwound. The method is described as “flying” or “on-the-fly” because the splice is made without the need to stop or slow down the unwinding of the expiring roll of material.

Flying splice operations may be of particular importance to the printing and paper industry. However, the typical adhesive tape used to provide a flying splice of a paper substrate may not be well suited to provide a flying splice of non-paper substrates, for example, filmic substrates comprising olefins with low surface energy. The surface energy of the adhesive relative to the surface energy of the substrate affects the ability of the adhesive to flow and cover the surface of the substrate. As such, the size of the contact area between the adhesive and the substrate is a function of the difference in surface energy of the adhesive and the substrate. Additionally, a flying splice tape may be used to provide a flying splice of substrates used in high tension and/or high temperature processes. Adhesives used in high tension and/or high temperature processes may need to possess high shear and cohesive strength in order for the flying splice to withstand the high tensions and/or high temperatures. Further, the flying splice tape must also have high tack for its substrate, as flying splice operations commonly have short contact times for attachment and bonding.

These desirable properties may not be present in all adhesives. For example, typical flying splice adhesives possessing high shear and cohesive strength may also possess a high surface energy and therefore adhere poorly to low surface energy substrates. Further, these adhesives may have low tack for low surface energy substrates and may not attach effectively when contact times are short as is typical in a flying splice operation. Thus, the use of these high shear and high cohesive strength adhesives on low surface energy substrates may result in the failure of the new roll of material to adhere to the expiring roll of material in the flying splice operation.

Conversely, flying splice adhesives that easily adhere to low surface energy substrates must possess surface energies as low or lower than the substrate. As such, these adhesives tend to be softer and tackier, which are desirable properties for adhering to low surface energy substrates during shorter contact times. However, the softness of these low surface energy adhesives results in low shear and low cohesive strength properties. High shear and cohesive strength properties may be required for some high tension and/or high temperature processes in which flying spice operations are desired. As such, a flying splice provided by these softer and tackier adhesives may fail in a high tension and/or high temperature process, and this may result in the splice failing further in the web path of the processing machine.

### SUMMARY

In an embodiment, an adhesive tape for providing a flying splice of low surface energy substrates is provided. The adhesive tape comprises an adhesive layer and a backing adjacent to the adhesive layer; wherein the adhesive layer comprises a first adhesive comprising a higher shear resistance, cohesive strength, and surface energy relative to a second adhesive, and the second adhesive comprising a higher tack for low surface energy substrates relative to the first adhesive; wherein the second adhesive is different from the first adhesive; wherein the second adhesive is adjacent to the first adhesive; wherein there is substantially no overlap between the first adhesive and second adhesive.

Additionally or alternatively, the adhesive tape may include one or more of the following features individually or in combination: a splitting strip adjacent to the backing and positioned on the opposing side of the backing relative to the adhesive layer; a leading edge liner adjacent to and covering at least a portion of the first adhesive; a contact side liner adjacent to and covering the second adhesive and at least a portion of the first adhesive; the adhesive layer may be a first adhesive layer and the adhesive tape may further comprise a second adhesive layer adjacent to the backing and positioned on the opposing side of the backing relative to the first adhesive layer and the second adhesive layer may comprise the first adhesive; the first adhesive layer may comprise the second adhesive in two distinct locations; the first adhesive layer may comprise the second adhesive in one location; a release liner may cover the first adhesive layer.

In an embodiment, a method of providing a flying splice on a low surface energy substrate is provided. The method comprises providing an adhesive tape comprising an adhesive layer and a backing adjacent to the adhesive layer; wherein the adhesive layer comprises a first adhesive and a second adhesive; wherein the second adhesive is different from the first adhesive; wherein the second adhesive is adjacent to the first adhesive; and wherein there is substantially no overlap between the first adhesive and second adhesive. The method further comprises applying the adhesive layer to a top winding of a first roll of the low surface energy substrate and contacting the applied adhesive layer with an expiring second roll of the low surface energy substrate without stopping or slowing the unwinding of the expiring second roll of the low surface energy substrate.

Additionally or alternatively, the method may include one or more of the following features individually or in combination: the low surface energy substrate may be a polyolefin, polyamide, polyethylene terephthalate, polyvinyl chloride, or a combination thereof; the first adhesive may comprise a higher shear resistance, cohesive strength, and surface energy relative to the second adhesive; the second adhesive may comprise a higher tack for low surface energy substrates relative to the first adhesive; the first adhesive may comprise a surface energy greater than the surface energy of the low surface energy substrate; the second adhesive may comprise a surface energy equal to or less than the surface energy of the low surface energy substrate; the first adhesive may comprise a bond strength on a low surface energy substrate of at least 8 N/cm or greater and the second adhesive comprises a bond strength on the low surface energy substrate of at least 1 N/cm or greater.

In an embodiment, a method of rewinding a low surface energy substrate on a core is provided. The method comprises providing an adhesive tape comprising an adhesive layer and a backing adjacent to the adhesive layer; wherein the adhesive layer comprises a first adhesive comprising a higher shear resistance, cohesive strength, and surface energy relative to a second adhesive, and the second adhesive comprising a higher tack for low surface energy substrates relative to the first adhesive; wherein the second adhesive is different from the first adhesive; wherein the second adhesive is adjacent to the first adhesive; wherein there is substantially no overlap between the first adhesive and second adhesive. The method further comprises applying the first adhesive of the adhesive layer to the core; wherein the core comprises a non-low surface energy material; and contacting the second adhesive of the adhesive layer with the low surface energy substrate.

Additionally or alternatively, the method may include one or more of the following features individually or in combination: the first adhesive may comprise a surface energy greater than the surface energy of the low surface energy substrate; the second adhesive may comprise a surface energy less than the surface energy of the low surface energy substrate; the low surface energy substrate may be a polyolefin, polyamide, polyethylene terephthalate, polyvinyl chloride, or a combination thereof; the first adhesive may comprise a bond strength on a low surface energy substrate of at least 8 N/cm or greater and the second adhesive may comprise a bond strength on the low surface energy substrate of at least 1 N/cm or greater.

The present disclosure and advantages associated therewith will become readily apparent in view of the detailed description provided below, including the accompanying drawings.

### BRIEF DESCRIPTION OF THE DRAWINGS

Illustrative examples of the present disclosure are described in detail below with reference to the attached drawing figures, which are incorporated by reference herein, and wherein:

FIG. 1A illustrates a cross-section of an adhesive tape in accordance with certain embodiments of the present disclosure;

FIG. 1B illustrates a top-down perspective of the adhesive tape of FIG. 1A along line A-B in accordance with certain embodiments of the present disclosure;

FIG. 2 illustrates a cross-section of the adhesive tape of FIG. 1A adhered to a new roll of material in accordance with certain embodiments of the present disclosure;

FIG. 3 illustrates a cross-section of the adhesive tape of FIG. 1A when used to provide a flying splice of a new roll of material to an expiring roll of material in accordance with certain embodiments of the present disclosure;

FIG. 4A illustrates a cross-section of another embodiment of an adhesive tape in accordance with certain embodiments of the present disclosure;

FIG. 4B illustrates a top-down perspective of the adhesive tape of FIG. 4A along line A-B in accordance with certain embodiments of the present disclosure;

FIG. 5 illustrates a cross-section of the adhesive tape of FIG. 4A adhered to a new roll of material in accordance with certain embodiments of the present disclosure;

FIG. 6 illustrates a cross-section of the adhesive tape of FIG. 4A when used to make a flying splice of a new roll of material to an expiring roll of material in accordance with certain embodiments of the present disclosure;

The illustrated figures are exemplary only and are not intended to assert or imply any limitation with regard to the environment, architecture, design, or process in which different examples may be implemented.

### DETAILED DESCRIPTION

The present disclosure relates to adhesive tapes used for making flying splices, and more particularly, to single-sided and double-sided adhesive tapes comprising a combined adhesive system to improve adherence on low surface energy substrates in a flying splice operation.

Unless otherwise indicated, all numbers expressing quantities of components, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

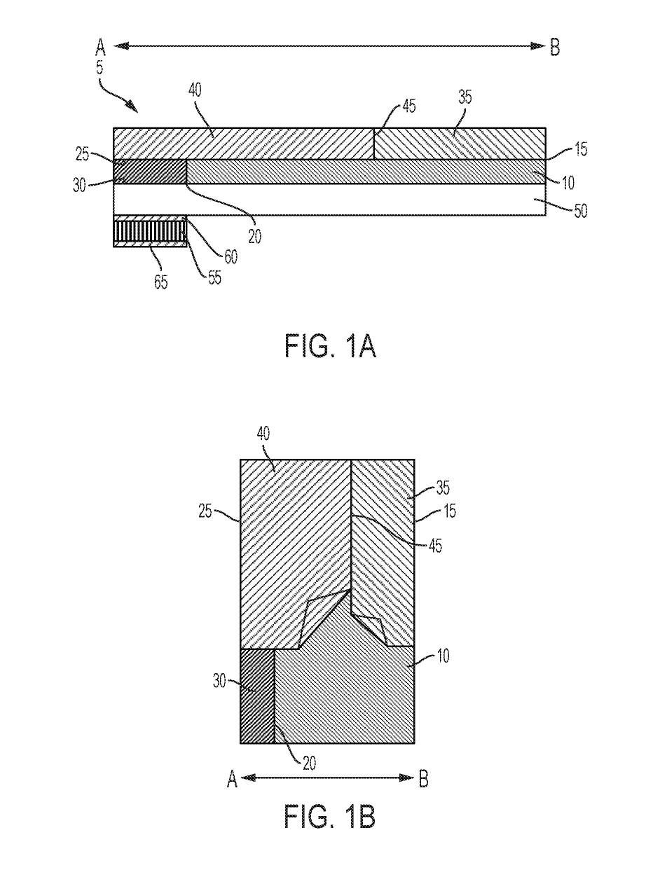

FIG. 1A illustrates a cross-section of an adhesive tape 5 in accordance with certain embodiments of the present disclosure. FIG. 1B illustrates a top-down perspective of adhesive tape 5 along line A-B in accordance with certain embodiments of the present disclosure. Adhesive tape 5 is a single-sided adhesive tape possessing one layer of adhesive. Adhesive tape 5 comprises a first adhesive 10 extending from a first lateral edge 15 to a position 20 that may be proximate a second lateral edge 25. A second adhesive 30 may be positioned adjacent first adhesive 10 and extend from second lateral edge 25 to position 20. Second adhesive 30 may be positioned adjacent first adhesive 10 such that there is substantially no overlap between second adhesive 30 and first adhesive 10 and consequently, no increase in overall thickness of adhesive tape 5 due to overlapping of the adhesives. First adhesive 10 and second adhesive 30 are composed of different adhesives. First adhesive 10 may possess a higher shear resistance and cohesive strength relative to second adhesive 30. The shear resistance and cohesive strength properties are to be of a sufficient value necessary for maintaining the flying splice in a specific high tension and/or high temperature process. Second adhesive 30 possesses a higher tack for low surface energy substrates relative to first adhesive 10. Second adhesive 30 should possess a tack sufficient to adhere a new roll of a low surface energy material to an expiring roll of a low surface energy material in a flying splice operation with a short contact time between the second adhesive 30 and the low surface energy material. First adhesive 10 may possess a higher surface energy relative to second adhesive 30. As such, second adhesive 30 may be a softer adhesive than first adhesive 10.

As illustrated, first adhesive 10 and second adhesive 30 are lined with a leading edge liner 35 and a contact side liner 40. Leading edge liner 35 extends from first lateral edge 15 to position 45, which is proximate first lateral edge 15. Contact side liner 40 extends from second lateral edge 25 to position 45.

A backing 50 (obscured in FIG. 1B) is positioned adjacent to and on the opposite side of the first adhesive 10 and the second adhesive 30 relative to the leading edge liner 35 and contact side liner 40. The backing 50 may be made of a polyester, polyethylene (e.g., polyethylene terephthalate), polypropylene (e.g., oriented polypropylene, biaxially oriented polypropylene), or more generally, any filmic substrate sufficient for carrying the first adhesive 10 and the second adhesive 30. In some optional embodiments, the backing 50 may be repulpable. In further optional embodiments, the backing 50 may be treated, for example, by increasing the surface energy of the backing material, to better promote adhesion of the first adhesive 10 and the second adhesive 30 to the backing 50.

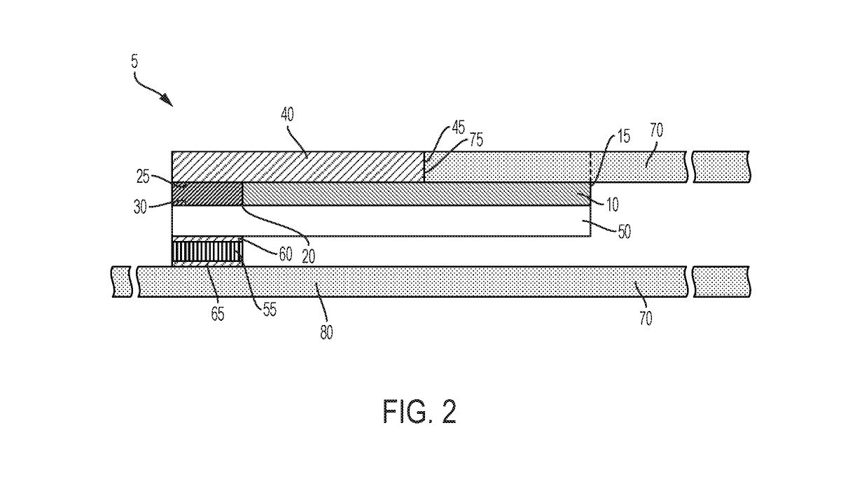

On the side of the backing 50 opposite the first adhesive 10 and the second adhesive 30, a splitting strip 55 (obscured in FIG. 1B) may be positioned. The splitting strip 55 may be used to secure the top winding of the new roll of material (illustrated in FIG. 2 below) from premature unwinding. Generally, the splitting strip 55 may tear and split apart at a plane running through the splitting strip 55 where cohesion is the weakest. This splitting may occur when the top winding of the new roll of material is unwound from the remaining windings after the flying splice operation has completed. The splitting strip 55 is adjacent to two adhesive layers, a backing adhesive layer 60 and a substrate adhesive layer 65. The backing adhesive layer 60 adheres the splitting strip 55 to backing 50. The backing adhesive layer 60 may comprise any adhesive sufficient for adhering the splitting strip 55 to the backing 50. The adhesive force of the backing adhesive layer 60 should be greater than the cohesive forces maintaining the integrity of the splitting strip 55, such that the splitting strip 55 may split and separate as desired and the backing adhesive layer 60 should not separate from the backing 50 or the splitting strip 55. The substrate adhesive layer 65 adheres the splitting strip 55 to the second from the top winding of the new roll of material. The substrate adhesive layer 65 should comprise an adhesive sufficient for attachment to a low energy surface substrate, and the adhesive force of the substrate adhesive layer 65 should be greater than the cohesive forces maintaining the integrity of the splitting strip 55 such that the splitting strip 55 splits and separates as desired and the substrate adhesive layer 65 does not separate from the splitting strip 55 or the new roll of material (as illustrated below).

FIG. 2 illustrates a cross-section of adhesive tape 5 when adhered to a new roll of material 70 in accordance with certain embodiments of the present disclosure. As illustrated, the leading edge liner has been removed (i.e., leading edge liner 35 as illustrated in FIGS. 1A and 1B), and the leading edge 75 of the new roll of material 70 is brought to a position adjacent to or proximate to position 45. The leading edge 75 is adhered to adhesive tape 5 by first adhesive 10, a portion of which was exposed by the removal of the leading edge liner, discussed above.

The second from the top winding 80 of the new roll of material 70 is affixed to the splitting strip 55 of adhesive tape 5 by substrate adhesive layer 65. As such, premature unwinding of the leading edge 75 of the top winding from the new roll of material 70 may be prevented when the new roll of material 70 is accelerated. With adhesive tape 5 adhered to both the leading edge 75 and the second from the top winding 80 of the new roll of material 70, the new roll of material 70 may be brought to contact with the moving expiring roll of material (as illustrated below). When said contact is desired, the contact side liner 40 may be removed prior, exposing second adhesive 30 and the remaining portion of first adhesive 10.

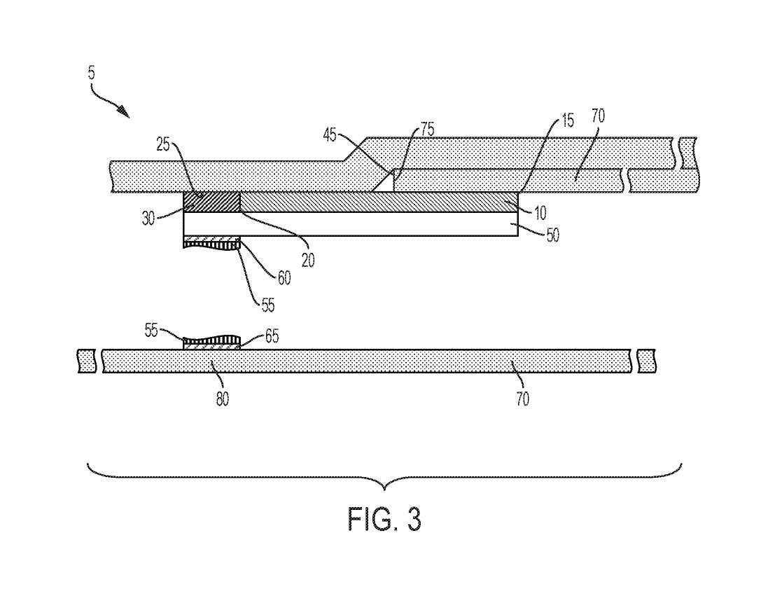

FIG. 3 illustrates a cross-section of adhesive tape 5 used to provide a flying splice of a new roll of material 70 to an expiring roll of material 85 in accordance with certain embodiments of the present disclosure. As was illustrated by FIG. 2, the adhesive tape 5 was adhered to both the leading edge 75 and the second to top winding 80 of the new roll of material 70. The new roll of material 70 may then be sufficiently resistant to centrifugal force and to wind such that it could be brought to rotational speed with the expiring roll of material 85 after the contact side liner is removed (i.e., contact side liner 40 as illustrated in FIG. 2). Contact between the new roll of material 70 and the expiring roll of material 85 may thus be made. As illustrated by FIG. 3, at the point of contact, the second adhesive 30 and the first adhesive 10 may adhere the expiring roll of material 85 to the adhesive tape 5. As discussed above, second adhesive 30 may be softer and tackier than first adhesive 10 and may allow a flying splice to be made when the contact time between the new roll of material 70 and the expiring roll of material 85 is short as the rotational speed of the new roll of material 70 is increased approximately to that of the expiring roll of material 85. After the flying splice is made, the top winding comprising the leading edge 75 of the new roll of material 70 is detached from the second from the top winding 80 of the new roll of material 70 when the force of the unwinding of the new roll of material 70 splits the splitting strip 55. As such, a flying splice may be provided without stopping or slowing the unwinding of the expiring roll of material 85.

Without limitation by theory, the second adhesive 30, possessing increased tack for the substrate of the expiring roll of material 85, allows the flying splice to be made when contact times between the new roll of material 70 and the expiring roll of material 85 are short. The second adhesive 30 thus allows for the flying splice to be started and for the leading edge 75 to be pulled from the new roll of material 70. The first adhesive 10, possessing high shear and cohesive strength, allows the flying splice to be maintained when the flying splice is pulled through a material processor and subjected to dynamic tensions and high temperatures.

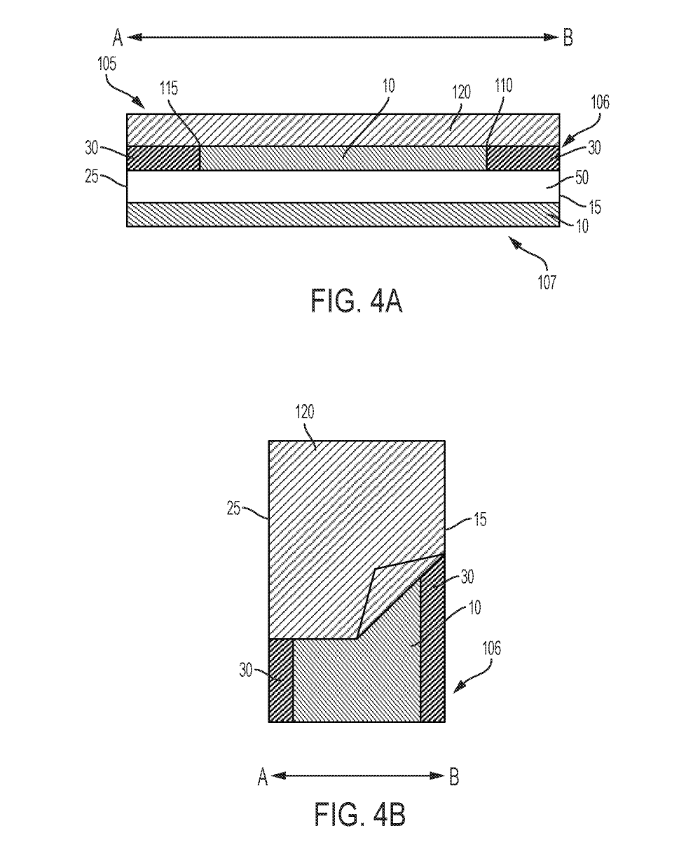

FIG. 4A illustrates a cross-section of another embodiment of an adhesive tape, generally 105, in accordance with certain embodiments of the present disclosure. FIG. 4B illustrates a top-down perspective of adhesive tape 105 along line A-B in accordance with certain embodiments of the present disclosure. Adhesive tape 105 is a double-sided adhesive tape possessing two layers of adhesives. The first adhesive layer 106 is positioned on the upper or top side of backing 50 (i.e., the outward facing side of the roll of adhesive tape 105) and comprises the first adhesive 10 and second adhesive 30. First adhesive 10 extends from position 110 proximate the first lateral edge 15 to a position 115 proximate the second lateral edge 25. A second adhesive 30 may be positioned adjacent to both edges of first adhesive 10 and extend from first lateral edge 15 to position 110 and also extend from second lateral edge 25 to position 115. Second adhesive 30 may be positioned adjacent first adhesive 10 such that there is substantially no overlap between second adhesive 30 and first adhesive 10 and consequently, no increase in overall thickness of adhesive tape 105 due to overlapping adhesives. Although second adhesive 30 is illustrated in two distinct locations in FIGS. 4A and 4B, in alternative embodiments second adhesive 30 may only be present in one location, and first adhesive 10 would extend to the respective lateral edge of the location absent second adhesive 30. Adhesive tape 105 further comprises a second adhesive layer 107. The second adhesive layer 107 comprises a first adhesive 10, adjacent to, and on the under or lower side of backing 50 (i.e., the inward facing side of the roll of adhesive tape 105) and extending from a first lateral edge 15 to a second lateral edge 25.

As discussed above regarding the embodiment illustrated in FIGS. 1A-3, first adhesive 10 and second adhesive 30 are composed of different adhesives. First adhesive 10 may possess a higher shear resistance and cohesive strength relative to second adhesive 30. The shear resistance and cohesive strength properties are to be of a sufficient value necessary for maintaining the flying splice in a specific high tension and/or high temperature process.

Second adhesive 30 possesses a higher tack for low surface energy substrates relative to first adhesive 10. Second adhesive 30 should possess a tack sufficient to adhere a new roll of a low surface energy material to an expiring roll of a low surface energy material in a flying splice operation with a short contact time between the second adhesive 30 and the low surface energy material. First adhesive 10 may possess a higher surface energy relative to second adhesive 30. As such, second adhesive 30 may be a softer adhesive than first adhesive 10.

As illustrated, the first adhesive 10 and second adhesive 30 of the first adhesive layer 106 are lined with a release liner 120 which covers all of first adhesive 10 and second adhesive 30 and may be removed to expose first adhesive 10 and second adhesive 30 of the first adhesive layer 106 when a flying splice is to be provided.

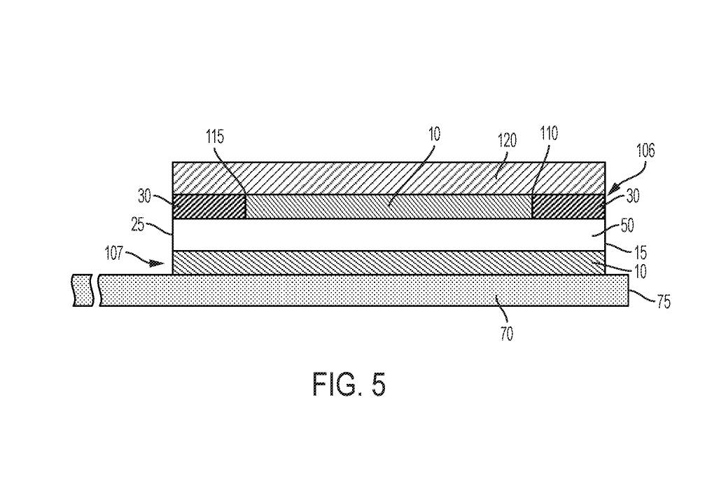

FIG. 5 illustrates a cross-section of adhesive tape 105 adhered to a new roll of material 70 in accordance with certain embodiments of the present disclosure. As illustrated, when desired for use, a strip of adhesive tape 105 may be placed on top of the top winding of a new roll of material 70 at or proximate to the leading edge 75 of the top winding. Before placement, one or more hold-down tabs (not shown) as are known in the art may be placed to secure the leading edge 75 to the second from the top winding 80. It is within the purview of one of ordinary skill in the art to know how to place hold-down tabs if desired. Alternatively, a splitting strip (e.g., splitting strip 55 as illustrated in FIGS. 1A-3) may be affixed to the underside of the second adhesive layer 107 and adhered to the second from the top winding (e.g., in a method analogous to the method illustrated in FIGS. 2-3) to secure the leading edge 75 from premature detachment due to centrifugal force when accelerated. When adhered to the new roll of material 70, the adhesive tape 105 may be used to contact an expiring roll of material in a flying splice operation. Prior to said contact, the release liner 120 may be removed, exposing first adhesive 10 and second adhesive 30 of the first adhesive layer 106.

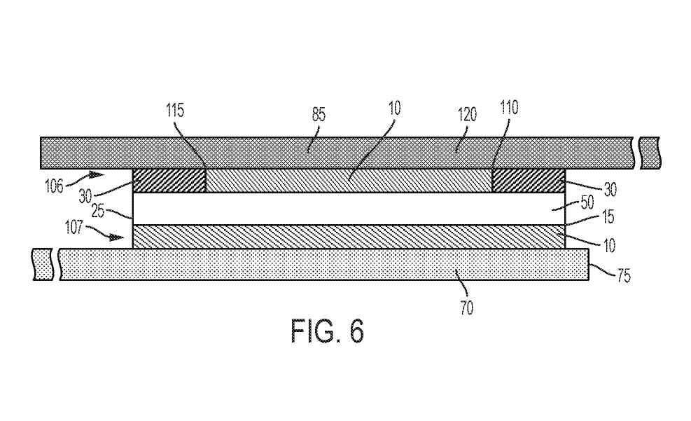

FIG. 6 illustrates a cross-section of adhesive tape 105 used to make a flying splice of a new roll of material 70 to an expiring roll of material 85 in accordance with certain embodiments of the present disclosure. With the adhesive tape 105 adhered to the new roll of material 70, the release liner (e.g., release liner 120 as illustrated in FIG. 5) may be removed to expose the first adhesive 10 and second adhesive 30 of first adhesive layer 106, and contact between the new roll of material 70 and the expiring roll of material 85 may then be made. At the point of said contact, the second adhesive 30 and the first adhesive 10 may adhere the expiring roll of material 85 to the adhesive tape 105. As discussed above, second adhesive 30 may be softer and tackier than first adhesive 10 and may provide a flying splice when the contact time between the new roll of material 70 and the expiring roll of material 85 is short as the rotational speed of the new roll of material 70 is increased approximately to that of the expiring roll of material 85. After the flying splice is provided, the top winding comprising the leading edge 75 of the new roll of material 70 may be detached from the second from the top winding 80 of the new roll of material 70 when the force of the unwinding of the top winding of the new roll of material 70 splits the hold-down tab or splitting strip, if present. As such, a flying splice may be provided without stopping or slowing the unwinding of the expiring roll of material 85.

As discussed above regarding the embodiment presented in FIGS. 1A-3, and without limitation by theory, the second adhesive 30, possessing increased tack for the substrate of the expiring roll of material 85, allows the flying splice to be made when contact times between the new roll of material 70 and the expiring roll of material 85 are short. The second adhesive 30 thus allows for the flying splice to be started and for the leading edge 75 to be pulled from the new roll of material 70. The first adhesive 10, possessing high shear and cohesive strength, allows the flying splice to be maintained when the flying splice is pulled through a material processor and subjected to dynamic tensions and high temperatures.

Additionally, the first adhesive 10 and the second adhesive 30 are sufficient for other operations that may utilize low surface energy materials. For example, the adhesive tape 105 may be used in a core starting operation wherein the tape is applied to a core and a material such as a low surface energy material is rapidly wound around the core. In an example core starting operation, which may take proceed after processing of the low surface energy substrate (e.g., printing, coating, slitting etc.) in the flying splice operation described above, the processed low surface energy substrate may be rewound on a core in the end of the processing machine. In continuous processes (i.e., not-stopping operations), automatic rewinders can be used. In these systems, adhesive tape 5 and/or adhesive tape 105 as described above in FIGS. 1A-6 may be affixed to the core to rewind the low surface energy substrate on the core. The first adhesive 10 may adhere to the core and the second adhesive 30 may adhere to the low surface energy substrate as it is rewound ensuring that it does not separate from the core as the second adhesive 30 possess increased tack for the low surface energy substrate. The adhesive tape 5 and/or adhesive tape 105 thus allows for the processed low surface energy substrate to be rewound on a core in a core starting operation. Examples of core materials may be paper, aluminum, steel, PVC. Generally, the core starting material is not a low surface energy material.

With reference to FIGS. 1A-6, the first adhesive 10 and the second adhesive 30 are rubber-based adhesives. The first adhesive 10 and the second adhesive 30 possess specific properties sufficient for the applications disclosed herein. Some of the testing methods used to determine the requisite minimum baseline for possession of the aforementioned properties are detailed as follows:

A bond strength test (Test A) was performed to determine the desired minimum bond strength of the first adhesive 10 and the second adhesive 30 on a specific example of a low surface energy substrate. A determination of the bond strength on polyethylene panel film was carried out. The sample adhesive tape for investigation comprised a standard polyethylene terephthalate carrier or paper backing having a thickness of 25 μm (PET) or 65 μm (paper), coated on one side with the first adhesive 10 or the second adhesive 30. A strip of the sample adhesive tape 10 to 28 mm wide was pressed under load (2 kg) onto the fixed polyethylene panel film. Immediately thereafter, the sample adhesive tape was peeled from the polyethylene panel film at an angle of 180° and a speed of 300 mm/min, and the force required to accomplish this at 23° C. temperature was measured.

A rolling ball tack test (Test B) was performed to determine the minimum tack of the first adhesive 10 and the second adhesive 30 on a specific example of a substrate with a low contact time. The determination of the tack of the first adhesive 10 and the second adhesive 30 on a steel ball was carried out as follows: adhesive tape samples (i.e., a specific embodiment of first adhesive 10 or the second adhesive 30) were rolled over at least 5 times with a 5.7 g stainless steel ball having a diameter of 7/16 inches (11.112 mm). The balls are cleaned accordingly before use (e.g., with heptane and acetone). The adhesive samples are fixed onto a base plate. The steel balls are rolled down a ramp with an incline of 30° and a rolling length of 6.5 inches. The ramp is placed flat on the adhesive samples, such that the ball exist the ramp directly on to the adhesive samples. The maximum rolling distance is then calculated from an average of the samples. The determination was made under test conditions of 23±1° C. and 50±5% relative humidity.

A microshear travel test (Test C) was performed to determine the minimum shear strength of bonded samples of the first adhesive 10 with a specific example of a low surface energy substrate. The determination of the shear strength of the first adhesive 10 under a temperature load of 40° C. was carried out as follows: adhesive tape samples (i.e., a specific embodiment of first adhesive 10) were adhered to a stainless steel plate, and then rolled over 3 times with a 2 kg steel roller at a speed of 12 m/min. The sample was then loaded at one end with a weight of 100 g. The test plate was then heated to the desired temperature load of 40° C. A measurement was made of the slip travel of the sample over a period of 15 minutes. After these first 15 minutes the weight was removed, and the relaxation was measured for a period of a further 15 minutes. The elastic component was computed (in %), which represents a measure of the network density. The testing was performed at a room temperature of 23° C. and a relative humidity 50%. The average measurement value was 35 μm, with the maximum being 55 μm.

Based on the above testing, embodiments of the first adhesive 10 possess a bond strength (Test A) on the low surface energy substrates described herein of at least 8 N/cm or greater. Embodiments of the first adhesive 10 possess a rolling ball distance (Test B) on the substrates described herein 25 mm or less. Embodiments of the first adhesive 10 possess a cohesion corresponding to a microshear travel test (Test C) on the low surface energy substrates described herein of less than 55 μm. In some embodiments, the first adhesive 10 may possess a surface energy greater than that of the low surface energy substrates described herein. In some embodiments, the first adhesive 10 may possess a surface energy greater than that of the second adhesive 30 described herein.

Based on the above testing, embodiments of the second adhesive 30 possess a bond strength (Test A) on the low surface energy substrates described herein of at least 1 N/cm or greater. Embodiments of the second adhesive 30 possess a rolling ball distance (Test B) on the substrates described herein 20 mm or less. In some embodiments, the second adhesive 30 may possess a surface energy lower than that of the low surface energy substrates described herein. In some embodiments, the second adhesive 30 may possess a surface energy less than that of the first adhesive 10 described herein.

The embodiments described herein may be of particular benefit in applications using low surface energy substrates. “Low surface energy” substrates as described herein, are any materials having a surface energy between 20-40 mN/m (dyn/cm). Examples of low surface energy substrates may include polyolefins, for example, polyethylene, polypropylene, and the like. Any variety of polyethylene (hereafter “PE”) may be a low surface energy substrate as described herein, including, but not limited to, low-density, linear low-density, medium-density, high-density, chemically modified PE, and the like. Any variety of polypropylene (hereafter “PP”) may be a low surface energy substrate as described herein, including, but not limited to, biaxially oriented, mono oriented, cast, pearled, and the like. Additional examples of low surface energy substrates may include polypropylene terephthalate (hereafter “PET”), polyamides, polyvinyl chloride (hereafter “PVC”), or combinations thereof.

One or more illustrative examples incorporating the embodiments disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations may be made herein without departing from the spirit and scope of the disclosure as defined by the following claims.

What is claimed is:

1. An adhesive tape for providing a flying splice of low surface energy substrates, the adhesive tape comprising:
an adhesive layer comprising:
a first adhesive comprising a higher shear resistance, cohesive strength, and surface energy relative to a second adhesive, and
the second adhesive comprising a higher tack for low surface energy substrates relative to the first adhesive; wherein the second adhesive is different from the first adhesive; wherein the second adhesive is adjacent to the first adhesive; wherein there is substantially no overlap between the first adhesive and second adhesive, and
a backing adjacent to the adhesive layer.

2. The adhesive tape of claim 1, further comprising a splitting strip adjacent to the backing and positioned on the opposing side of the backing relative to the adhesive layer.

3. The adhesive tape of claim 1, further comprising a leading edge liner adjacent to and covering at least a portion of the first adhesive.

4. The adhesive tape of claim 1, further comprising a contact side liner adjacent to and covering the second adhesive and at least a portion of the first adhesive.

5. The adhesive tape of claim 1, wherein the adhesive layer is a first adhesive layer; wherein the adhesive tape further comprises a second adhesive layer adjacent to the backing and positioned on the opposing side of the backing relative to the first adhesive layer; wherein the second adhesive layer comprises the first adhesive.

6. The adhesive tape of claim 5, wherein the first adhesive layer comprises the second adhesive in two distinct locations.

7. The adhesive tape of claim 5, wherein the first adhesive layer comprises the second adhesive in one location.

8. The adhesive tape of claim 5, further comprising a release liner covering the first adhesive layer.

9. A method of providing a flying splice on a low surface energy substrate.
providing an adhesive tape comprising:
an adhesive layer comprising:
a first adhesive, and
a second adhesive; wherein the second adhesive is different from the first adhesive; wherein the second adhesive is adjacent to the first adhesive; wherein there is substantially no overlap between the first adhesive and second adhesive, and
a backing adjacent to the adhesive layer;
applying the adhesive layer to a top winding of a first roll of the low surface energy substrate;
contacting the applied adhesive layer with an expiring second roll of the low surface energy substrate without stopping or slowing the unwinding of the expiring second roll of the low surface energy substrate.

10. The method of claim 9, wherein the low surface energy substrate is a polyolefin, polyamide, polyethylene terephthalate, polyvinyl chloride, or a combination thereof.

11. The method of claim 9, wherein the first adhesive comprises a higher shear resistance, cohesive strength, and surface energy relative to the second adhesive.

12. The method of claim 9, wherein the second adhesive comprises a higher tack for low surface energy substrates relative to the first adhesive.

13. The method of claim 9, wherein the first adhesive comprises a surface energy greater than the surface energy of the low surface energy substrate.

14. The method of claim 9, wherein the second adhesive comprises a surface energy equal to or less than the surface energy of the low surface energy substrate.

15. The method of claim 9, wherein the first adhesive comprises a bond strength on a low surface energy substrate of at least 8 N/cm or greater and the second adhesive comprises a bond strength on the low surface energy substrate of at least 1 N/cm or greater.

16. A method of rewinding a low surface energy substrate on a core, the method comprising:
providing an adhesive tape comprising:
an adhesive layer comprising:
a first adhesive comprising a higher shear resistance, cohesive strength, and surface energy relative to a second adhesive, and
the second adhesive comprising a higher tack for low surface energy substrates relative to the first adhesive; wherein the second adhesive is different from the first adhesive; wherein the second adhesive is adjacent to the first adhesive; wherein there is substantially no overlap between the first adhesive and second adhesive, and
a backing adjacent to the adhesive layer;
applying the first adhesive of the adhesive layer to the core; wherein the core comprises a non-low surface energy material;
contacting the second adhesive of the adhesive layer with the low surface energy substrate.

17. The method of claim 16, wherein the first adhesive comprises a surface energy greater than the surface energy of the low surface energy substrate.

18. The method of claim 16, wherein the second adhesive comprises a surface energy less than the surface energy of the low surface energy substrate.

19. The method of claim 16, wherein the low surface energy substrate is a polyolefin, polyamide, polyethylene terephthalate, polyvinyl chloride, or a combination thereof.

20. The method of claim 16, wherein the first adhesive comprises a bond strength on a low surface energy substrate of at least 8 N/cm or greater and the second adhesive comprises a bond strength on the low surface energy substrate of at least 1 N/cm or greater.
